(19) United States
(12) Patent Application Publication
(10) Pub. No.: US 2025/0238395 A1
(43) Pub. Date: Jul. 24, 2025

(54) A COMPUTER PROCESSOR

(71) Applicant: TECHNISCHE UNIVERSITÄT BERLIN, Berlin (DE)

(72) Inventor: Tobias KAISER, Berlin (DE)

(21) Appl. No.: 18/853,927

(22) PCT Filed: Mar. 29, 2023
(86) PCT No.: PCT/EP2023/058151

§ 371 Date: Oct. 3, 2024

(30) Foreign Application Priority Data
Apr. 12, 2022 (DE) 10 2022 108 884.7
Aug. 18, 2022 (DE) 10 2022 120 941.5

(51) Int. Cl. G06F 15/80

(52) U.S. Cl. CPC G06F 15/8046

(57) ABSTRACT

A processing element array of a processor, comprising a plurality of processing elements or nodes, each of the processing elements including at least one instruction register, a control unit, at least one arithmetic or logic unit, and one or more storage elements, and being configured to store, decode and execute an instruction; the instruction register and the storage elements are configured to be writable from one or more data buses; and the arithmetic or logic unit is configured to receive input from one of the storage elements and to output a result to one or more other processing elements of the array of processing elements via the one or more data buses. Also, a fabric cell or tile of a processor, comprising such a processing element array, an S bus that constitutes the data bus, and a cell or tile interface node. The interface node connects an external message bus to the S bus of the fabric cell; the S bus implements the datapath of the processing elements, and facilitates data exchange between the processing elements, and between the interface node and the cell or tile interface node and processing elements; and the interface node comprises a plurality of message registers and is configured to forward instructions to the processing elements, coordinate eviction and restoring locally, and assist the processing elements during the execution of communication and fragment instance management instructions.

### RELATED APPLICATIONS

The present application is based on and claims the benefit of the filing dates of German patent applications nos. 10 2022 108 884.7 filed 12 Apr. 2022 and 10 2022 120 941.5 filed 18 Aug. 2022, the content of which as filed is incorporated herein by reference.

### FIELD OF THE INVENTION

The present invention relates to a computer processor.

### BACKGROUND

Field-programmable gate arrays and coarse-grained reconfigurable arrays (FPGAs and CGRAs) are universal computing architectures that combine decentral data storage and routing resources with large numbers of arithmetic and logic circuits. Instead of machine code organized in instructions, configuration data is loaded into their computing fabrics to implement specific functionalities. Unlike an instruction stream, configuration data remains largely stationary. Operation irrespective of an instruction stream allows architectures to surpass conventional processors in energy efficiency. However, they are difficult targets for sequential programming and thus not typically used to run complex application software. Prior research examined the use of custom-tailored compilers. EDGE ISAs such as TRIPS aim to improve support for general-purpose computing.

Spatial array structure recurs as theme in many alternative computing approaches such as dataflow computing and in-place processing.

Dataflow architectures proceed with separate computational operations as operands become available, rather than by following control flow encoded in an instruction stream. Their primary goal is to take advantage of instruction-level parallelism. They distribute dataflow operations to spatial arrays. Similar to reconfigurable architectures, dataflow architectures require specialized programming and have so far not gained widespread adoption.

For a wider range of software to benefit from advantages of reconfigurable and dataflow computing, simple programming interfaces that do not require modification of existing software are deemed crucial. Such software transparency can either be achieved at compile time, using toolchains that are aware of heterogeneous target architectures, or at runtime using dynamic binary translation.

Two example architectures that rely on modified compiler toolchains to achieve software transparency are disclosed by Mishra et al. in Tartan: Evaluating spatial computation for whole program execution (ACM SIGOPS Operating Systems Review, 40(5) (2006) pp. 163-174) and Papadopoulos and Culler in Monsoon: An explicit token-store architecture (ACM SIGARCH Computer Architecture News, 18(2SI) (1990) pp. 82-91. The former combines a conventional CPU with a dataflow processor, to which particularly suitable program parts are offloaded. The latter incorporates reconfigurable cores to increase energy efficiency.

Dynamic binary translation (DBT) has been used to target very-long instruction word (VLIW) architectures. There has also been considerable research on reconfigurable fabrics as DBT target. Typical approaches in this domain augment CPUs by reconfigurable functional units to speed up execution of recurring instruction chains.

In-place processing (IPP) is a design approach for CPUs. While conventional processors decode and issue instructions centrally, IPP architectures distribute subsequent instructions to a spatial array of processing elements, where they are decoded and executed decentrally. IPP was pioneered by Ultrascalar and CRIB with objectives of simplifying and improving superscalar processing.

DiAG, an IPP architecture with RISC-V compatibility, adds an instruction reuse mechanism: after initial execution, its instructions remain loaded in their processing elements. When they are subsequently encountered, fetch and decode operations can be omitted. This reduces switching and saves energy. Binary compatibility to existing instruction sets make IPP architectures compelling software targets.

The reduction of fetch and decode operations is also the purpose of the Loop Stream Detector of Intel (trade mark): on repeated executions of small loops, fetch and decode stages are suspended and a previously recorded control sequence is played back from a local buffer.

A related approach stores recent instructions with their operands and results in a reuse buffer to improve performance and branch prediction during subsequent executions.

Reduced instruction set computing (RISC) emerged in the 1980s. Its success is reflected in today's computing landscape, in the form of derived instruction sets such as RISC-V and ARM, with processors known for energy efficiency.

FIG. 1 is a schematic diagram of an existing in-place microprocessor processing architecture 10, which has N processing elements (PEs) 12 each with an arithmetic-logic unit (ALU) 14 and an output register 16 that receives a result from ALU 14. Processing architecture 10 includes K general-purpose registers (GPRs) 18. PEs 12 receive inputs from GPRs 18 and communicate with one another via GPRs 18.

Processing architecture 10 uses register-lane datapath structures (see Henry et al. in The Ultrascalar processor-an asymptotically scalable superscalar microarchitecture, 1999 (DOI: 10.1109/ARVLSI.1999.756053), Gunadi and Lipasti in CRIB: Consolidated rename, issue, and bypass (ACM SIGARCH Computer Architecture News, 39(3) (2011) pp. 23-32) and Wang and Kim in DiAG: A dataflow-inspired architecture for general-purpose processors (Proceedings of the 26th ACM International Conference on Architectural Support for Programming Languages and Operating Systems, ACM, April 2021)). B indicates the data path width. One register lane emulates the functionality of a single GPR and is connected to every PE 12 using one write port and two read ports. In processing architecture 10, a linear sequence of multiplexers assures read and write ordering. Register lanes form a dense connection matrix between PEs 12 that allows an arbitrary number of writes to be carried out simultaneously. This architecture is well-suited for executing conventional RISC instruction sets, where dataflow is encoded through GPRs, and the register lanes can accommodate superscalar execution.

RISC instruction sets are designed for pipelined microarchitectures adhering to the traditional fetch-decode-execute instruction cycle. Branch or jump targets are the only cases in which they encode spatial information directly. However, instructions also form groups of high cohesion and interrelate by dataflow. When instructions are to be executed in a spatially distributed manner, knowledge of spatial groupings and interrelations is crucial. Unraveling this information from a RISC instruction stream at runtime is expensive.

### Summary

It is an object of the present invention to address the gap between instruction encoding and architecture, by providing a processor architecture and/or instruction set architecture to facilitate RISC-like programming of a computer processor structured as an array (such as a coarse-grained reconfigurable array (CGRA)).

According to a first aspect of the invention, there is provided a processing element array of a processor, comprising:
a plurality of processing elements or nodes, each of the processing elements including at least one (e.g. one or two) instruction register, a control unit, at least one (e.g. one or two) arithmetic or logic unit (such as one or more arithmetic-logic units or ALUs), and one or more storage elements, and being configured to store, decode and execute an instruction;
wherein the instruction register (which receives instructions and any optional prefixes) and the storage elements are configured to be writable from one or more data buses; and
the arithmetic or logic unit is configured to receive input from one of the storage elements and to output a result to one or more other processing elements of the array of processing elements via the one or more data buses.

This array may be described as a coarse-grained reconfigurable array (CGRA).

It is envisaged that each processing element would typically have one instruction register, but in some applications a plurality of instruction registers may be beneficial. For example, a plurality of instruction registers could be used as cache for fragment code.

Similarly, it is envisaged that each processing element would typically have one arithmetic or logic units, but one or more of the processing elements could have one or more additional arithmetic or logic units to support (a) vector processing (SIMD=single instruction, multiple data); (b) other data types such as floating point numbers; and possibly (c) superscalar execution (i.e. more than one instruction per cycle).

There is also flexibility in the number of arithmetic or logic units per processing element, as a plurality of smaller units could be employed instead of a single arithmetic or logic unit that performs all of the required operations. Each of the smaller units would handle some of the operations (subtract, add, and, or, xor, shift, etc) otherwise performed by the arithmetic or logic unit. Thus, a reference to an arithmetic or logic unit herein includes reference to such an alternative configuration.

It will be noted that the at least one arithmetic or logic unit is configured to receive input from one of the storage elements, but this does not exclude its also receiving input from other sources. This could be any source of data that it is desired be processed. For example, in the embodiment described below by reference to FIG. 5, operand registers A and B are written (i) by the TIP mechanism from other processing elements; and (ii) initialized with immediate values or zero; for reading data from an external source, a separate operand register R is used, which operand register can receive data from a cell or tile interface node, which in turn can receive data from a message (M) bus. The M bus data can come from memory, a fragment instance manager, or any source connected to an external memory interface, such as I/O devices in the form of—for example—one or more sensors or communication modules.

In an embodiment, the arithmetic or logic unit is configured to pass the result to one or more storage elements of the other processing elements of the array of processing elements.

In an embodiment, each of the processing elements includes a third storage element writable from the data bus and a multiplexer intermediate the first storage element and the arithmetic-logic unit, the multiplexer being configured to receive inputs from the first and third storage elements and to pass selected outputs to the arithmetic-logic unit.

In an embodiment, each of the processing elements includes a control unit configured such that when an instruction encodes a conditional branch, the control unit determines a branch decision based on a send type of the instruction and the result outputted by the arithmetic-logic unit being zero.

In an embodiment, the instructions encode operations that are basic enough to require no intermediate translation into microinstructions before execution.

In an embodiment, the instructions have respective formats that facilitate simple fetching and decoding.

In an embodiment, the instructions support a minimal set of operand types and less common operand types require dedicated instructions. For example, each of the processing elements may receive input data primarily from two storage elements that are statically associated with the respective processing element.

In an embodiment, the instruction register of a first processing element of the plurality of processing elements supports a plurality of target instruction pointers, defining respective logical connections between the first processing element and one or more other processing elements of the plurality of processing elements;
one or more of the target instruction pointers are configured for dataflow coordination (e.g. send opA, send opB) or control flow coordination (e.g. branch on zero, branch unless zero); and
one or more of the target instruction pointers are configured for dataflow coordination.

It should be noted that the reference in this embodiment to the first processing element does not refer to any particular processing element, as the role of the first processing element can be assumed by any of the processing elements having an instruction register.

According to a second aspect of the invention, there is provided a fabric cell or tile of a processor, comprising:
a processing element array of the first aspect;
an S bus that constitutes the data bus; and
a cell or tile interface node;
wherein the interface node connects an external message bus to the S bus of the fabric cell;
the S bus implements the datapath of the processing elements, and facilitates data exchange between the processing elements, and between the interface node and the cell or tile interface node and processing elements; and
the interface node comprises a plurality of message registers and is configured to forward instructions to the processing elements, coordinate eviction and restoring locally, and assist the processing elements during the execution of communication and fragment instance management instructions.

In an embodiment, the fabric cell or tile comprises one or more S/T links for connecting the S bus to respective S buses of one or more adjacent fabric cells or tiles via respective T links. The interface node may serve as an interface for a plurality of like fabric cells or tiles.

According to a third aspect of the invention, there is provided a processor, comprising:
a plurality of fabric cells or tiles of the second aspect;
a message bus;
a fragment instance manager;
a fragment instance table; and
a memory.

The fragment instance table decodes fragment instance addresses (FIAs) and generates enable signals for message bus endpoints. The fragment instance manager and memory are addressed using special static FIAs, while FIAs for the tiles may be dynamic. The FIAs may be limited to eight bits. The fragment instance table may also store fragment code addresses for all cells/tiles.

The processor may be configured to reuse machine code that remains in a cell/tile after fragment instance termination, in case the same fragment is invoked again shortly after.

The fragment instance manager is responsible for invocation, termination and FIA allocation. In an embodiment, it implements a simple scheduling algorithm and initiates fragment loading, evict and restore operations. It may, during evict and restore, modify FIT entries accordingly.

In an embodiment, the processor implements dynamic tiling so as to support linkage of a plurality of tiles. For example, the processor may implement dynamic tiling so as to support linkage of two or four tiles to accommodate fragments of up to 64 instructions.

It should be noted that any of the various individual features of each of the above aspects of the invention, and any of the various individual features of the embodiments described herein, including in the claims, can be combined as suitable and desired.

### DRAWINGS

In order that the invention may be more clearly ascertained, embodiments will now be described by way of example with reference to the following drawing, in which:

FIG. 1 is a schematic view of a processing architecture of the background art.

FIG. 2A is a schematic view of a processor core according to an embodiment of the present invention.

FIG. 2B is a schematic view of a processor comprising the processor core of FIG. 2A, according to an embodiment of the present invention.

FIG. 3 is a schematic diagram of one possible processing architecture of the processor of FIG. 2B, according to an embodiment of the present invention.

FIG. 4A is a schematic view of the architecture of the processor of FIG. 2B.

FIG. 4B is a schematic view of one fabric cell or tile of the processor of FIG. 2B.

FIG. 4C is a schematic view of an implementation of a processing element or node of the processor of FIG. 2B.

FIG. 5 presents a summary of instruction formats of an instruction set according to an embodiment of the present invention.

FIG. 6A shows an encoding used for a message register of a fragment instance (FI) according to an embodiment of the present invention.

FIG. 6B shows a packed encoding used by the sum opA+opB to specify a machine code start address of an invoked fragment and a return message index (RMI) according to an embodiment of the present invention.

FIG. 7A shows a fragment that performs two subroutine calls to gcd to calculate the greatest common divisor of three numbers according to an embodiment of the present invention.

FIG. 7B shows an example of an iterator coroutine according to an embodiment of the present invention for invoking and printing bits from a generator coroutine.

FIG. 7C shows an example of a generator coroutine that implements a Galois linear-feedback shift register according to an embodiment of the present invention.

FIG. 7D shows an exemplary quicksort for utilizing multithreading capabilities according to an embodiment of the present invention.

FIG. 8 is a simplified schematic diagram of a PE array of a processing architecture according to another embodiment of the present invention.

### DETAILED DESCRIPTION

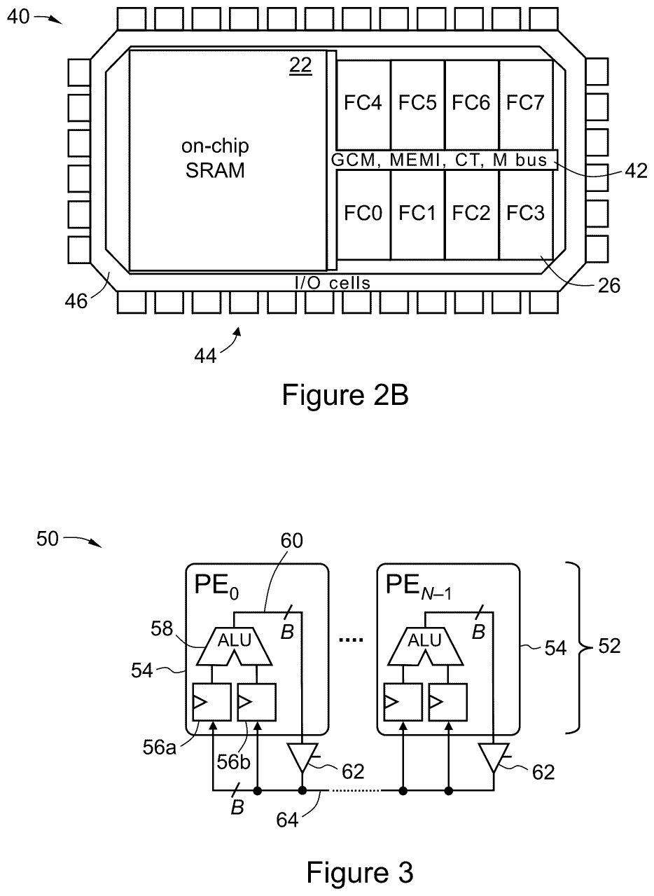

FIG. 2A is a schematic overview of a processor core 20 according to an embodiment of the present invention. Processor core 20 includes a 256 kB on-chip SRAM 22 (to quantize energy impact of memory accesses) and a compute fabric 24 with one or more (and in this example, up to eight) fabric cells or tiles (FCs) 26. The selection of the number of FCs 26 balances two main considerations: more FCs 26 require more silicon area, but may provide better performance and better energy efficiency. A single FC 26 is also viable, but may provide poor performance and energy efficiency.

In this example, there are two rows (FC0 to FC3 and FC4 to FC7), each of four FCs. In each row of FCs 26, each pair of adjacent FCs (e.g. FC0 and FC1) is linked with a T link 28. In addition to compute fabric 24, core 20 includes a global call manager (GCM) 30, a call table (CT) 32 and a memory interface (MEMI) 34. FCs 26, GCM 30 and MEMI 34 are interconnected through an M (message) bus 36.

M bus 36 is a single-layer interconnect that allows 32-bit word transfers in a single clock cycle. Every message on M bus 36 is directed at exactly one endpoint. Endpoints of M bus 36 are addressed with frame pointers (FP). MEMI 34 and GCM 30 are mapped to fixed FP addresses. The eight FCs 26 are dynamically mapped to FP addresses. This dynamic mapping is performed by CT 32. CT 32 can be modified by GCM 30. Central static priority arbitration is used to ensure that only one endpoint gets to send on M bus 36 in each clock cycle. A special bus hold signal can be used to transfer multiple words subsequently and guarantee that the transfer is not interrupted by an endpoint with higher static priority. M bus 36 also allows endpoints to inhibit reception of further messages through a busy signal. As some endpoints having multiple addresses, the busy signal ensures that core 20 cannot incur a deadlock.

FIG. 2B is a schematic floorplan of a processor 40, according to an embodiment of the present invention, that includes processor core 20. In addition to the components of core 20 (including interconnect logic 42 for GCM 30, MEMI 34, CT 32 and M bus 36), processor 40 includes a conventional ring of I/O cells 44 and a conventional ring 46 of pads that surround core 20 of processor 40.

Processor 40 is configured to follow six principles:
1. Instructions encode operations that are basic enough to require no intermediate translation into microinstructions before execution.
2. Instruction formats are as regular as possible to allow simple fetching and decoding.
3. Instructions support only a minimal set of operand types.
4. Less common operand types require dedicated instructions.
5. Fixed limits on aspects of the execution context simplify instruction set and microarchitecture. Where possible, limits should be sufficiently large to not restrict or complicate common programming cases.
6. The instruction set should allow simple microarchitectures and leave room for future optimization and upscaling.

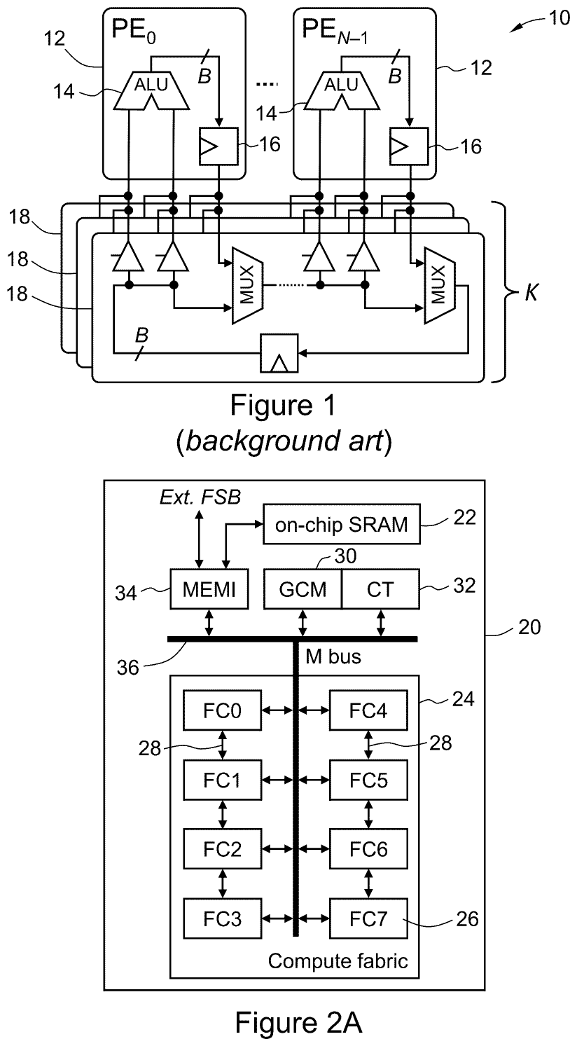

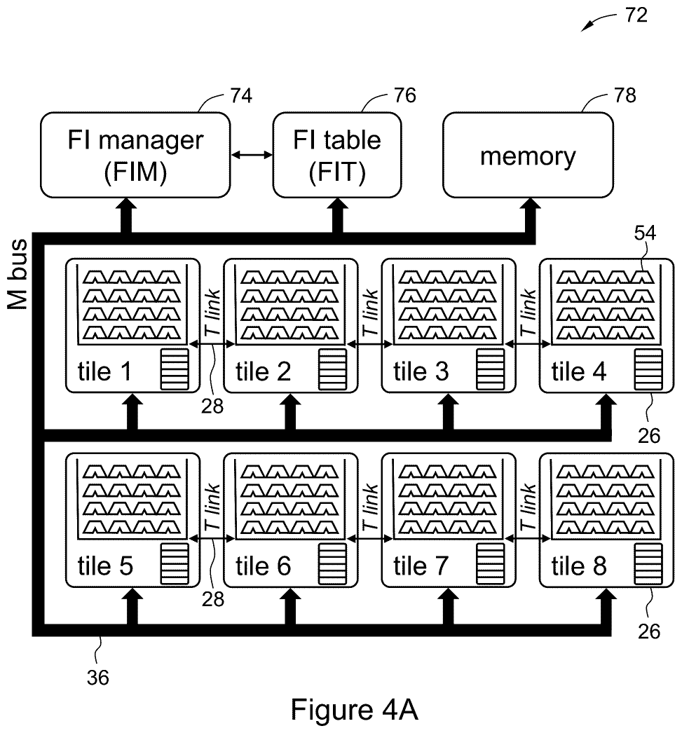

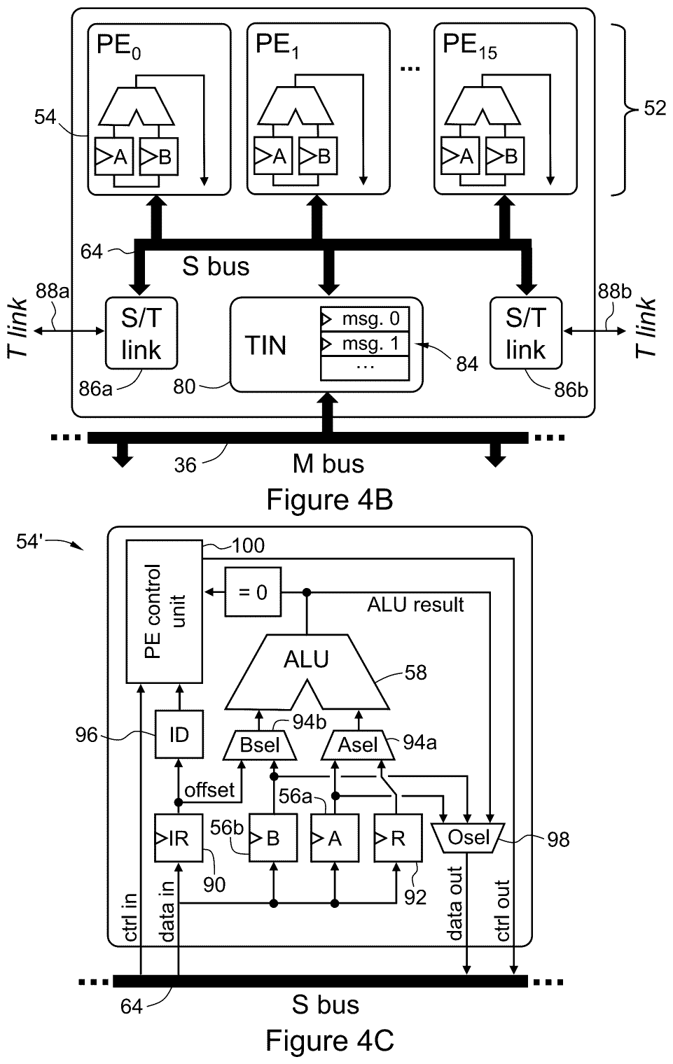

FIG. 3 is a schematic diagram of one possible processing architecture 50 of processor 40, according to an embodiment of the present invention. Note that FIGS. 4A and 4B (described below) provide a more detailed overview of how the S bus interconnects different components in the context of the architecture, but FIG. 3 provided as a simple illustration of the distinction between architectures according to the present invention and background art architectures, such as DiAG and architecture 10 of FIG. 1 (and in particular to illustrate how a data bus may be implemented according to the invention).

Processing architecture 50 includes an array 52 of N processing elements or nodes (PEs) 54 (viz. PE₀ to PE_{N-1}). In this example, N is 16 such that processing architecture 50 includes PE₀ to PE₁₅, but it should be understood that—in this and other embodiments—the array may have more or fewer PEs.

Each PE 54 includes first and second storage elements in the form of first and second operand registers 56a, 56b and an arithmetic or logic unit in the form of an ALU 58, with an output 60 of ALU 58 connected via a mechanism 62 for combining multiple data source outputs (in this example in the form of a tri-state driver, but alternatively employing—for example—a multiplexer or combinational logic gate) to a shared data bus (or S bus) 64. The datapath of architecture 50 allows every PE 54 to send its result to shared data bus 64. A PE 54 can use one of first and second registers 56a, 56b to receive operands from this shared data bus 64. B again indicates datapath width.

Each PE 54 is able to hold a single instruction, which it decodes and then executes as necessary.

Thus, architecture 50 has a send-based datapath design that is simpler than architecture 10 of FIG. 1, and the datapath of architecture 50 has approximately 4K times fewer combinational logic resources (where K is the number of register lanes) to implement than the register lane datapath of FIG. 1A. When only a single instruction is executed per cycle, the datapath of architecture 50 suffices for distributing the instruction's result to other storage elements.

Notably, the datapath of architecture 50 restricts source operands of regular instructions to two fixed storage elements. Principle 3 underpins this design choice. It simplifies instruction encoding and keep logic paths short.

It should be noted that the S bus may be built in many other ways without departing from the present invention, and many applications will have reason to depart from the illustrated architecture of FIG. 3. For example, a logarithmic interconnect structure may be more energy efficient. Additionally, multi-layer buses could enable superscalar execution and thus allow better performance. However, FIG. 3 (especially when compared with FIG. 1) shows that the costly structures that DiAG uses to execute RISC code in an array are not required according to the present invention.

FIG. 4A is a schematic view of the architecture 70 of processor 40. Processor 40 includes a variable number of cells or tiles or 26 (in the illustrated example, cells/tiles 1 to 8), each containing 16 PEs 54. Processor 40 also includes an F manager (FIM) 74, an F table (FIT) 76 and a memory 78. All components are interconnected using M bus 36. Dynamic tiling was implemented, permitting linkage of two or four tiles to accommodate fragments of up to 64 instructions.

FIG. 4B is a schematic view of one fabric cell or tile 26. Fabric cell 26 has a cell or tile interface node (TIN) 80 that connects the external M bus 36 with the internal S bus 64 of fabric cell 26. The S bus 64 implements the datapath described above (see FIG. 3, and shared data bus 64), and is used for data exchange between PEs 54 of PE array 52, and between TIN 80 and PEs 54. TIN 80 contains the eight message registers 84 that were defined as part of the ISA of this embodiment, in this example storing message 0 to message 7. TIN 80 forwards instructions to PEs 54, coordinates eviction and restoring locally, and assists PEs 54 during the execution of communication and F management instructions.

Fabric cell 26 includes first and second S/T links 86 (connected to S bus 64): in multi-tile allocations, S/T links 86a, 86b connect S buses of adjacent tiles via respective T links 88a, 88b. T links 88a, 88b are transparent when required, but inhibit unnecessary switching when an operand requires no propagation through a particular T link. TIN 80 of a first fabric cell/tile serves as interface for the entire set of cells/tiles.

FIG. 4C is a schematic view of an implementation of processing element (PE) 54′, in which like reference numerals have been used to identify like features. PE 54′ includes an instruction register (IR) 90, A, B and R storage elements in the form of operand registers 56a, 56b, 92, an A select multiplexer 94a, a B select multiplexer 94b, an instruction decoder (ID) 96, an ALU 58, an ALU output multiplexer 98, and a PE control unit 100. R register 92 is not exposed at the ISA level.

Primary instructions and any optional prefixes are loaded from S bus 64 into IR 90, which passes them to ID 96 where they are decoded. ID 96 passes the decoded instructions to PE control unit 100. PE control unit 100 also receives control signals from S bus 64, and passes control signals back to S bus 64.

A, B and R registers 56a, 56b, 92 are writable from S bus 64. A and B registers 56a, 56b are already known from the ISA specification.

A select multiplexer 94a receives input from A and R registers 56a, 92; B select multiplexer 94b receives an offset from IR 90 and input from R register 56b. ALU output multiplexer 98 receives input from A and B registers 56a, 56b and the ALU result from ALU 58.

Regular D instructions with opcode 000 (see Table 3, discussed below) are performed in one clock cycle. If an S prefix is used, a second cycle is taken for operand sending, because control signals for only two simultaneous storage element writes were implemented. If an instruction encodes a conditional branch, PE control unit 100 determines the branch decision based on the instruction's st1 value (see Table 1, discussed below) and result outputted by ALU 58 being zero. Neither branch decision entails a latency.

D instructions with opcode 001 (receive, load, invoke) send requests to the local TIN 80 through S bus 64. TIN 80 performs the requested operations, possibly using M bus 36, writes results to R register 92 and returns control to PE 54. PE 84 continues with regular operand sending. W instructions (send, store, term) operate by similar TIN interactions, but do not produce results.

The architecture 70 of processor 40 begins fragment execution only after loading the entire fragment's machine code. Instruction fetching is done with one word per cycle, which blocks the S bus from concurrent fragment execution.

Fragment instance addresses (FIAs) are used as addresses on M bus 36. The F table (FIT) decodes FIAs and generates enable signals for all M bus endpoints. FIM and memory are addressed using special static FIAs, while FIAs for tiles are dynamic. In the present embodiment, FIAs are limited to eight bits. The FIT also stores fragment code addresses for all tiles. With this, the architecture can reuse machine code that remained in a tile after F termination, in case the same fragment is invoked again shortly after.

The FIM is responsible for invocation, termination and FIA allocation; it implements a simple scheduling algorithm and initiates fragment loading, evict and restore operations. During evict and restore, it modifies FIT entries accordingly.

On reset, all tiles are assigned an FIA. The FIM maintains a pool of unused FIAs as a linked list in memory. As FIs are evicted and restored, unused FIAs are removed from and returned back to this list. A second linked list of FIAs, the ready queue, is maintained. It contains all suspended FIAs that are ready to resume execution.

When a message is addressed to an FIA that cannot be resolved by FIT lookup, it is assumed that the message targets an evicted FI. The message is delivered to memory with help of the FIM. In relevant cases, the FIA is enqueued in the ready queue.

If the FIM cannot meet a requested fragment invocation request with vacant tiles, a new FI is created in memory instead of fabric. As part of this operation, an FIA is removed from the unused list and enqueued in the ready queue.

A scheduling algorithm is implemented in hardware that aims to minimize switching activity rather than encourage multi-threading. When execution is stalled, the topmost F from the ready queue is restored. In the likely case that this is not possible due to F presence in fabric, F is are evicted from fabric until there is sufficient space to restore the topmost F from the ready queue.

F is are evicted in the order in which they have entered message wait state. For this purpose, the FIM uses an LRU (least recently used) unit.

A 256-bit wide memory bus connects the system to main memory. Instruction fetching is performed using a 256-bit buffer. For data memory accesses, a small, fully associative cache of 4×256 bits is used to reduce the number of main memory accesses.

To preserve a conventional sequential programming model, one PE 54 is active at any given time. Once finished, the active PE 54 passes control on to a successor PE 54. In the process, the previously active PE 54 becomes inactive and is only activated again when another PE 54 passes control back. This implements control flow in the absence of a program counter (such as that described by Parashar et al. in Efficient spatial processing element control via triggered instructions (IEEE Micro, 34(3) (2014) pp. 120-137)).

In accordance with principle 6, advanced microarchitectures can deviate from this scheme and execute multiple instructions at once, to the degree permitted by instruction-level parallelism.

Sequences in which instructions are executed and patterns in data exchange between instructions (cf. FIG. 1 of Swanson et al., WaveScalar, in Proceedings of the 36th Annual IEEE/ACM International Symposium on Microarchitecture, ser. MICRO 36, USA: IEEE Computer Society, (2003) p. 291) are highly local. Conventional processors regularly exploit this with pipelining and instruction caching. For array architectures, locality of data and control flow is crucial for spatial coordination between PEs.

To simplify this coordination problem, in this embodiment machine code is statically partitioned into fragments of up to Mₘₐₓ instructions. Fragments are delimited using explicit markers (cf. the approaches found in WaveScalar, Scheduled Dataflow and EDGE). As a first approximation, fragments can be thought of as subroutines of a program. A more detailed role analysis is presented below.

Observing principles 5 and 6, Mₘₐₓ is set to a fixed value high enough to enable significant algorithmic complexity and low enough to allow small hardware implementation.

Processor 40 employs processing tiles as hardware counterparts of fragments; these tiles are referred to herein as processing fabric. In the simplest case, one tile contains Mₘₐₓ PEs, allowing it to run any fragment. To increase utilization, however, processor 40 employs dynamic tiling: the number of PEs per tile divides Mₘₐₓ evenly. When fragments beyond the limit of a single tile enter or leave the fabric, adjacent tiles are linked or unlinked on the fly (cf. Composable Lightweight Processors).

The necessary fabric is allocated before a fragment is executed. After allocation, all instructions of a fragment are loaded into PEs 24 in their machine code order, disregarding control flow instructions in the process. If a PE 54 becomes active before its instruction is present, it must stall execution and wait for its instruction.

Instructions in PEs 24 need to exchange data to perform meaningful work. Dataflow within a fragment can be represented as local dataflow graph with instructions serving as nodes. An edge represents the transmission of results from its tail instruction to one of the head's storage elements. To write all necessary storage elements, the active instruction needs to identify all its direct successors in the dataflow graph. Different graph encodings are envisaged:
1. Common identifiers at source and sink: instructions encode three identifiers, two for their storage elements and one for their result. Results are written to storage elements with matching identifiers within the fragment.
2. Source instructions encode sinks: instructions encode a set of storage elements within the fragment, to which they send their result. The active PE uses this to assert write signals for all necessary storage elements.
3. Sink instructions encode sources: the reverse of scheme 2 is also possible. For each storage element, a set of source instructions could be encoded. Write signals are asserted decentrally by receiving PEs.

Only scheme 2 permits the execution of instructions before the entire fragment is loaded, as schemes 1 and 3 require information from instructions outside the currently active instruction.

Encoding scheme 1 is the closest to RISC's GPR mechanism. However, this similarity is problematic. Using the identifiers like GPRs would lead to unnecessary writes: all storage element marked as sink of a particular identifier are written, even when some of the written values will never be used. In some cases, it is guaranteed that the sink storage element is overwritten by another instruction before the sink instruction is reached by control flow. The sink instruction might also be unreachable from the source instruction. Even though functionally harmless, such unnecessary write operations potentially degrade energy efficiency.

Unnecessary edges can be eliminated with unique identifiers for either sources or sinks. Such unique identifiers make a both-sided encoding pointless, as instructions and storage elements can already be identified using their position in fabric.

In combination with a limited instruction length (principle 2), schemes 2 and 3 impose sparsity requirements on the dataflow graph, with scheme 2 limiting outdegree and scheme 3 limiting in degree.

Concerning encoding efficiency, assuming a variable-length instruction encoding and an unlimited number of edges encoded per instruction, the total encoding cost in both schemes 2 and 3 is proportional to the number of edges and to the number of instructions. Under those assumptions, encoding schemes 2 and 3 are equally efficient. When outdegree or in degree is limited due to an instruction length limit, supplemental instructions need to be added to the graph in order to send or receive data to or from more instructions than the encoding permits.

Even with fixed-length instructions and a fixed limit to the number of edges per instruction, those necessary graph modifications will lead to differences in total encoding costs between the two schemes.

In this embodiment, processor 40 is configured to employ scheme 2 for dataflow graph encoding, because scheme 2 permits execution without full fragment presence and prevents unnecessary writes.

Principles 2 and 3 encourage the reuse of the preferred dataflow encoding (scheme 2) for control flow. A branch of control flow targets an instruction within the fragment. This is similar to a dataflow edge that targets another instruction's storage element. In case of a branch, one bit less suffices as branch target address, as there is no need to select one of two storage elements. This bit can be reused to encode a one-bit branch condition.

Reentrancy is a desirable program code property. A reentrant subroutine can be executed a second time before its first invocation has been finished. It requires that data and control state of all of its ongoing invocations are maintained separately. For conventional subroutine calls, this is typically accomplished with a dynamic stack that holds local variables, saved registers and saved program counters.

In this embodiment, to enable fragment reentrancy, a fragment's machine code is separated from its execution state. The term fragment instance (FI) is used herein to refer to its execution state. The F encompasses storage element values, information which instruction is currently active and communication state. Multiple F is, including multiple instances of one fragment, can coexist in fabric. Coexisting F is are executed as separate threads.

A frame instance manager (FIM) is responsible for creating and terminating F is. The FIM maintains a mapping between F is and tiles. The FIM may be implemented as centralized hardware unit or in a distributed manner.

Desirably, fabric size should not limit the number of coexisting F is. When a program requires more coexisting F is than the fabric can accommodate, fragment persistence allows the transfer of F is between fabric and main memory. The present embodiment calls F transfer from fabric to memory eviction, the transfer back restoring.

The introduction of F persistence makes it necessary to determine scheduling of F is between fabric and memory. This distantly resembles cache replacement problems.

While the maximum number of F is that can be executed simultaneously depends on fabric size, the maximum number of F is that can coexist at any given time is limited only by main memory.

This enables small and large microarchitectures that are functionally equivalent (principle 6). In consequence, fabric scaling allows better performance, but does not restrict code compatibility.

The data and control flow encodings discussed above are only applicable within a fragment. The missing gap is filled by a network that connects tiles, FIM and main memory. This network is used for various purposes: F is can perform loads and stores by communicating with memory. F is can exchange data with each other or synchronize their control flow by passing messages. By interaction with the FIM, F is can spawn new F is. In accordance with principle 4, dedicated instructions should be defined for network operations.

F is are addressed using unique identifiers, which they can use to maintain a distributed graph of mutual references. This identifier is termed fragment instance address (FIA). FIAs must remain constant throughout F lifetime. They must remain valid throughout eviction and restoring and must be decoupled from physical tile location.

When a message is sent to an F that has been evicted, it must be delivered by modifying the FI's in-memory representation. Such message deliveries are crucial events for scheduling, as this short scenario demonstrates: A, an FI, calls a subroutine B and starts waiting for a message containing B's return value. During the execution of B, A is evicted. When B completes, its return value message is delivered to A's in-memory representation. This should trigger the FIM to immediately restore A to continue execution of A and B's common thread.

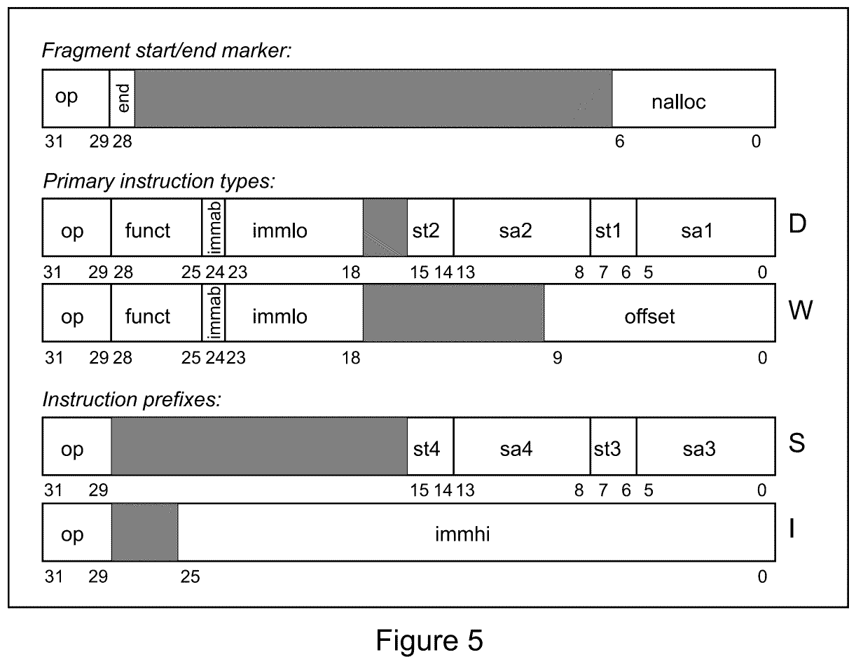

According to this embodiment, an instruction set (termed the ‘Pasithea-1 instruction set’ herein) is founded on the principles discussed above. Pasithea-1 uses 32-bit data words. Main memory is addressed using 32-bit wide byte addresses. Mₘₐₓ=64 was selected as fragment size limit. FIG. 5 and Tables 1 to 3 summarize the Pasithea-1 ISA.

Thus, FIG. 5 summarizes the instruction formats. Beginning and end of a fragment are marked with special start/end markers, as shown in FIG. 5. Its nalloc field encodes the fragment's number of instructions. This allows dynamic tile allocation directly after reading the fragment start marker. The additional fragment end marker is not strictly necessary, but simplifies fragment loading. Word alignment of instructions is required.

Instructions are encoded using either the D (data) or the W (write) format, also shown in FIG. 5. Deviating from a strict fixed-length encoding, prefix words can be placed before instructions. Such prefixes are loaded together with the corresponding primary instruction word into a single PE 54. Each PE 54 is assumed to have two storage elements, opA and opB. D instructions can send their result to multiple storage elements within the fragment. Furthermore, they can perform conditional branching within the fragment. W type instructions can neither perform storage element sends nor conditional branching.

The D instruction format can directly encode either two operand sends or one conditional branch and one operand send. The first send slot (or first target instruction pointer or TIP), consisting of send type 1 (st1) and send address 1 (sa1), can encode either a conditional branch or an operand send.

Table 1 shows the send type encoding. The send address field references an instruction within the fragment. The second send slot (or second TIP), consisting of send type 2 (st2) and send address 2 (sa2), differs from the first in that it can only encode an operand send. Prepending the D instruction with an S prefix allows for two more operand sends. Only one S prefix per instruction is allowed.

TABLE 1
the send type encoding

| stN or ttN | Function | N ∈ |
|---|---|---|
| 10 | send opA | 1, 2, 3, 4 |
| 11 | send opB | 1, 2, 3, 4 |
| 00 | branch on zero | 1 |
| 01 | branch unless zero | 1 |
| 0x | no operation | 2, 3, 4 |

(Note: the N of Table 1 should not be confused with N—the number of PEs in a PE array—of FIGS. 1 and 3.)

When an F is created, all its storage elements are set to known values. immab selects one of the two storage elements as target for initialization with an immediate value. The field immlo holds the least significant six bits of this immediate value. The I prefix can be used to specify the remaining 26 bits, enabling arbitrary 32-bit immediates. In absence of an I prefix, immlo is sign-extended, limiting immediate values to the range [−32 . . . 31]. The storage element that has not been selected with immab is initialized to zero.

Table 2 gives an overview of all Pasithea-1 instructions by mnemonic and corresponding operation.

TABLE 2
overview of Pasithea-1 instructions by mnemonic
& corresponding encoded operation

| Mnemonic | Format | Operation |
|---|---|---|
| or, and, xor, add, sub | D | res = ALU(opA, opB) |
| slt, sltu, sll, srl, sra | | |
| lw, lh, lb, lhu, lbu | D | res = Mem [opA + opB] |
| sw, sh, sb | W | Mem [opA + offset] = opB |
| recv (receive) | D | res = Msg [opA + opB] |
| | | (from local message regs) |
| Send | W | sends message (MI, data) to FIA with |
| | | data = opB and (FIA, MI) = (opA + |
| | | offset) |
| inv (invoke) | D | invokes fragment at addr using RMI as |
| | | return MI, with (addr, RMI) = (opA + |
| | | opB) and res = new FIA |
| term (terminate) | W | terminates current FI |

Table 3 shows how mnemonics are encoded in opcode and funct code.

TABLE 3
encoding of mnemonics in opcode and funct code

| | funct | | | | | | | | | |
|---|---|---|---|---|---|---|---|---|---|---|
| op | 0000 | 0001 | 0010 | 0011 | 0100 | 0101 | 0110 | 0111 | 1000 | 1001 |
| 000 | or | and | xor | add | sub | slt | sltu | sll | srl | sra |
| 001 | recv | Lb | lh | lw | lbu | lhu | inv | | | |
| 010 | send | sb | sh | sw | term | | | | | |

| | |
|---|---|
| 011 | S prefix |
| 100 | I prefix |
| 101 | Fragment start/end marker |

A set of basic integer ALU and memory access instructions, highlighted in FIG. 5 and Tables 1 to 3, is adopted from RISC-V (see Waterman and Asanovic, The RISC-V instruction set manual, volume I: User-level ISA, document version 2019121, RISC-V Foundation, Tech. Rep., 2019). This includes bit-wise logic instructions, arithmetic instructions, shift instructions, as well as load and store instructions. The different load and store instructions allow for different access sizes and optional sign extension. No dedicated control flow instructions are required, as any D instruction can perform conditional branching.

As described above, communication between F is, memory and the FIM is essential. Together with the instruction set, a communication model needs to be specified.

When a new FI is created, the FIM assigns it a 26-bit FIA. The base address of the fragment's in-memory representation can be derived from this FIA, coupling FIA allocation to memory allocation.

Every F can use the set of eight message registers 84 to receive messages from the network. Each message register can hold one data word. The message registers are addressed using a three-bit message index (MI). The number of message registers was chosen to provide sufficient space for parameters and return values, conforming to principle 5 (above).

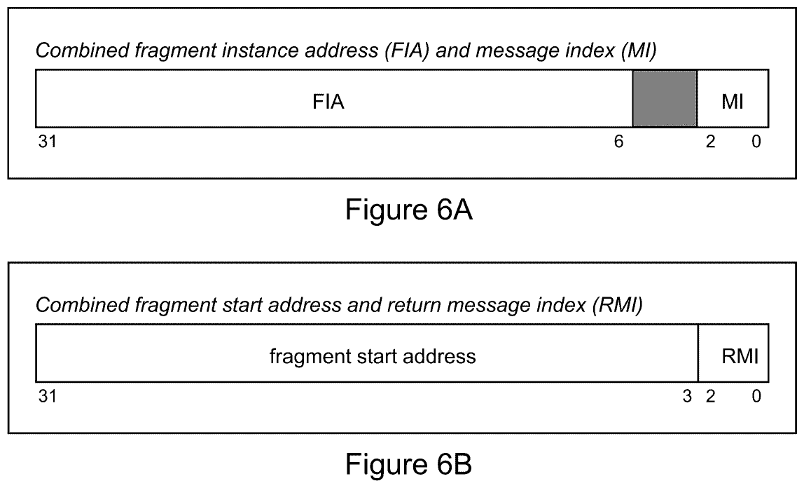

The send instruction sends a message to another FI's message register. The sum of opA and the offset field specifies FIA and MI of the targeted message register. FIG. 6A shows the encoding used. opB specifies the data that is written to the message register. If the targeted message register already contains data, it is overwritten.

The recv instruction is used to receive a message by reading one of the current FI's message registers. The least significant three bits of opA+opB determine the requested MI. If no message is present in the requested message register, recv waits for the reception of a message with the requested MI. After successful reception, the message register is cleared.

The instruction inv invokes a fragment by requesting the FIM to spawn a new FI. The sum opA+opB uses the packed encoding shown in FIG. 6B to specify both the machine code start address of the invoked fragment and the return message index (RMI). The invoking FI receives the FIA of the invoked FI as result value. It can be used to send parameters to the invoked fragment. On the side of the invoked FI, message register zero automatically receives the invoking FIA together with its chosen RMI. This allows the invoked FI to send results back to the invoking FI. The FIA/MI encoding shown in FIG. 6A is used for this. It is suitable for use in a subsequent send as opA.

The instruction term terminates the current FI.

The Pasithea-1 instruction set, described above, adopts many basic instructions from RISC-V. Meanwhile, with fragments, F is and operand sends, it differs significantly from RISC instruction sets. In this section, we therefore investigate how some common programming patterns can be translated to Pasithea-1 machine code.

According to this embodiment, it is possible to translate a simple iterative algorithm from an intermediate assembly-like language to machine code. In addition, fragments can be used as subroutines. While subroutines are probably the most common form of code encapsulation visible on machine-code level, modern programming also relies on asynchronous programming concepts and multi-threading, so below are demonstrated Pasithea-1's coroutine and fine-grained multi-threading capabilities.

In absence of a high-level language compiler, an assembly language is used for programming Pasithea-1. Manually defining operand sends for each instruction turned out infeasible for programming by hand. Therefore, an intermediate assembly-like language (IAL) has been devised according to this embodiment. In this IAL, instructions read and write local variables, the names of which start—in this example—with a $ sign. Simple dataflow analysis resolves those local variables to operand sends. This yields a programming interface similar to RISC assembly language, with local variables replacing GPRs. The following approximate syntax is used for instructions in IAL:
[L:][goto L (if|ifnot)][$var=]op(opA, [offset,]opB)

For translation into machine code, a per-fragment control and data flow graph (CDFG) is constructed. Similar approaches are used in high-level synthesis of digital circuits (see Amellal and Kaminska, Scheduling of a control data flowgraph, (IEEE International Symposium on Circuits and Systems, IEEE, 1993. DOI: 10.1109/ISCAS.1993.394061)) and in compilation for dataflow architectures (see Gurd et al., The Manchester prototype dataflow computer (Communications of the ACM, 28(1) (1985) pp. 34-52), Arvind and Nikhil, Executing a program on the MIT tagged-token dataflow architecture (IEEE Transactions on Computers, 39(3) (1990) pp. 300-318), Kavi et al., Scheduled dataflow: Execution paradigm, architecture, and performance evaluation (IEEE Transactions on Computers, 50(8) (2001) pp. 834-846) and Swanson et al., The WaveScalar architecture (ACM Transactions on Computer Systems, 25(2) (2007) pp. 1-54). In contrast to high-level synthesis and dataflow architectures, the present embodiment fully preserves machine instruction order and control flow from IAL source code.

Dataflow edges that are unnecessary due to control flow, described above, are pruned from the graph. In cases where more than four sends are required, supplemental or instructions are inserted. Unconditional jumps are implemented as conditional branches with constant operands. IAL also resolves tiny expressions and encodes resulting constants as immediates.

Table 4 shows an implementation of Euclid's algorithm to compute greatest common divisors (gcd) in IAL. Beside the program code, the CDFG is shown as adjacency matrix and the resulting sends are listed. Those sends are encoded in (st1,sa1) . . . (st4,sa4). An S prefix is only used for instructions with more than 2 sends, which are instructions 2 and 4 in the shown example. In the table, S=successor, C=conditional branch target, A=send opA, B=send opB, T=true=non-zero, F=false=zero. S, C, T and F relate to control flow, while A and B relate to dataflow.

TABLE 4
Euclid's greatest common divisor algorithm (gcd) in IAL

| | | | Send | Send | Send | Send |
|---|---|---|---|---|---|---|
| ↓ Source instruction | CDFG adjacency matrix | Fmt | 1 | 2 | 3 | 4 |

| | | | | | | | | | | | | | | |
|---|---|---|---|---|---|---|---|---|---|---|---|---|---|---|
| 0 | $p = recv(1, 0) | S | A | | | | | B | | D | 7.opB | 2.opA | | |
| 1 | $q = recv(2, 0) | | SB | | | | | | | D | 2.opB | | | |
| 2 | loop: goto end | | | SA | A | B | C | | | D | F→6 | 4.opA | 5.opB | 3.opA |
| | ifnot | | | | | | | | | | | | | |
| | $diff = sub($p, $q) | | | | | | | | | | | | | |
| 3 | goto p_lt_q if | | | | S | C | | | | D | T→4 | | | |
| | slt($diff, 0) | | | | | | | | | | | | | |
| 4 | goto loop if $p = | | CA | | | S | | B | | D | T→2 | 7.opB | 2.opA | |
| | or($diff, 0) | | | | | | | | | | | | | |
| 5 | p_lt_q: goto loop if | | CB | | | | S | | | D | T→2 | 2.opB | | |
| | $q = sub(0, $diff) | | | | | | | | | | | | | |
| 6 | end: $ci_ret = | | | | | | | SA | | D | 7.opA | | | |
| | recv(0, 0) | | | | | | | | | | | | | |
| 7 | send($ci_ret, 0, $p) | | | | | | | | S | W | | | | |
| 8 | \|term( ) | | | | | | | | | W | | | | |

| | | | | | | | | | |
|---|---|---|---|---|---|---|---|---|---|
| Target instruction → | 0 | 1 | 2 | 3 | 4 | 5 | 6 | 7 | 8 |

Instructions 0 and 1 receive two input values $p and $q from message registers 1 and 2. Instructions 2-5 form a loop. The loop is exited by a conditional jump from instruction 2 to instruction 6 when $p and $q are equal. Instructions 4 and 5 always branch to instruction 2, because their results are never zero. Instructions 6 reads the FIA/MI invoker reference from message register zero (see above). Instruction 7 uses this reference to send the greatest common divisor as return value to the invoking FA.

When a routine exceeds the size limit Mₘₐₓ, it is broken down into smaller fragments that communicate by message passing, by CDFG partitioning.

Typical application code uses hundreds of subroutines and performs millions of subroutine calls per second. A low overhead mechanism for subroutine calls is therefore crucial to their performance.

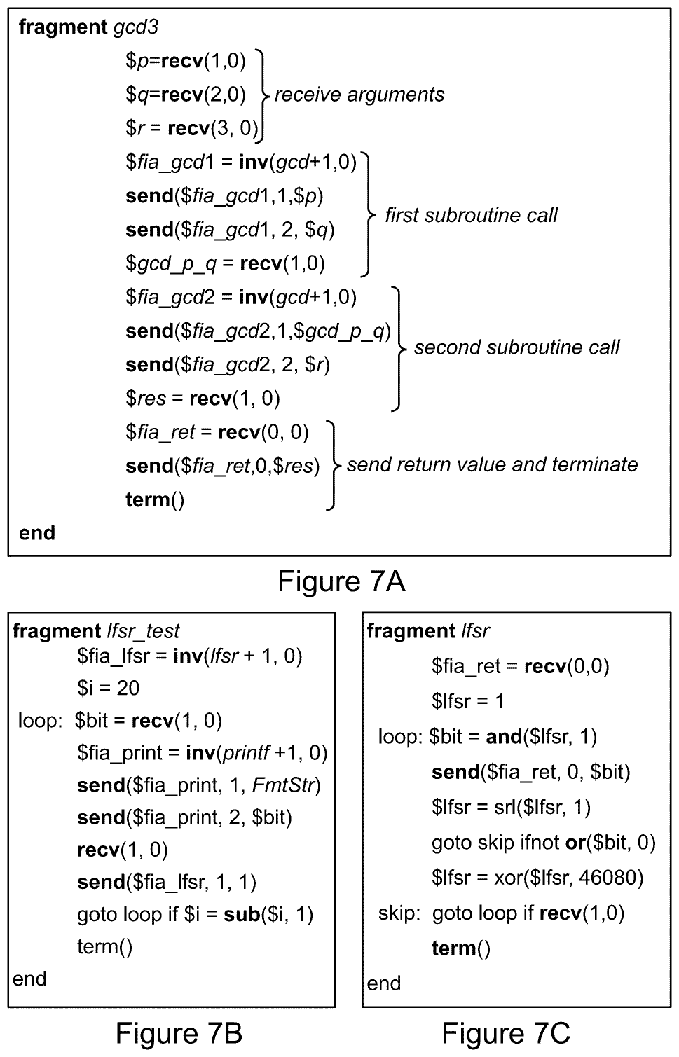

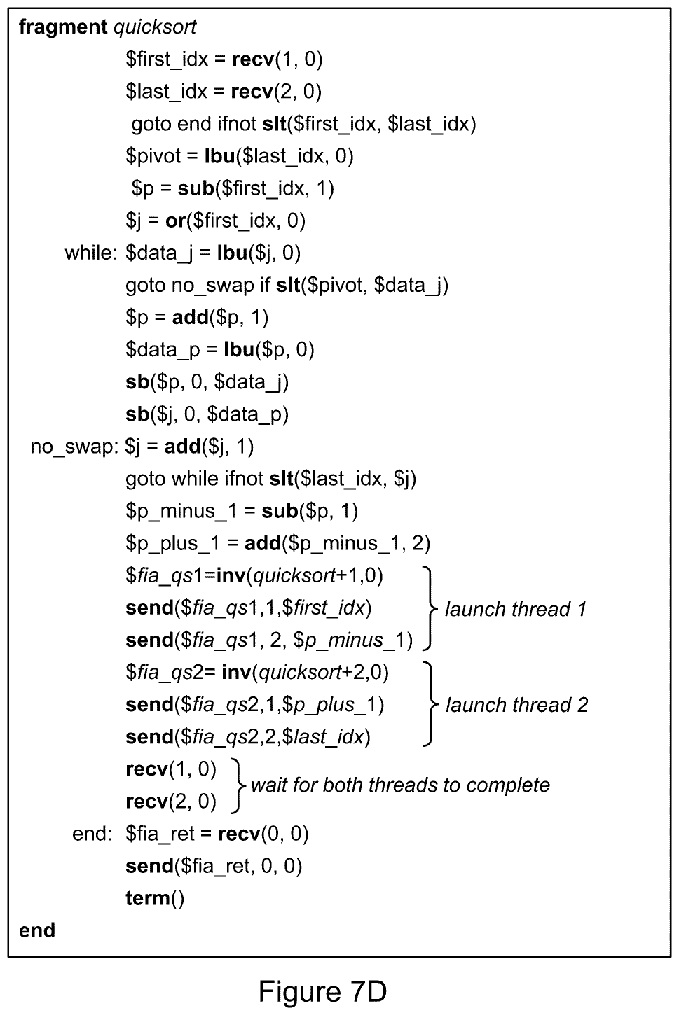

FIG. 7A shows a fragment that performs two subroutine calls to gcd to calculate the greatest common divisor of three numbers as gcd3(p,q,r)=gcd(gcd(p,q),r). Similarly to gcd, it starts by receiving arguments and ends with sending a return value. In between, two subroutine calls to gcd are performed.

Subroutine calls consist of three stages:
1. Fragment invocation: The requested subroutine fragment is invoked using inv. This returns an FIA that references the newly spawned FI. The new F automatically receives a reference to the invoker in message register zero (see above). The invoker furthermore provides a return message index (RMI) to the subroutine, which is 1 in this example.
2. Send arguments (optional): The invoker sends argument values to the message registers of the subroutine. By convention, the n-th argument is passed at MI=n.
3. Receive return values and synchronize control flow: Explicit synchronization is needed to ensure that the invoking F pauses until the subroutine is completed. This is done with receive instructions, which block until their requested message is received. Subroutines without return value need to return a blank message for synchronization. Multiple return values are possible. By convention, the n-th return value is passed at MI=RMI+(n−1).

Coroutines incorporate the full structural power of subroutines, but can pass control and data back and forth between each other without relinquishing their local state (see De Moura and lerusalimschy, Revisiting coroutines, ACM Transactions on Programming Languages and Systems, 31(2) (2009) pp. 1-31 and Knuth, The Art of Computer Programming, Volume 1 (3rd Ed.): Fundamental Algorithms [USA: Addison Wesley Longman Publishing Co., Inc., 1997], pp. 193-200). Asynchronous programming involving coroutines has been particularly successful in applications where many tasks are processed concurrently and tasks spend large fractions of their time waiting for I/O. Language developers have identified coroutines as “a natural way of expressing many algorithms, such as simulations, games, asynchronous I/O, and other forms of event-driven programming” (van Rossum and Eby, Coroutines via enhanced generators, PEP 342, 2005, https://peps.python.org/pep-0342/). Coroutine-like language constructs are present in many modern programming languages such as Python, C++, Rust, Go and JavaScript.

On conventional architectures, coroutines cooperatively yield control over the program counter to each other, conserving individual data and program counters in the process. In Pasithea-1, fragments can mimic this behavior using message passing and message-based synchronization.

FIGS. 7B and 7C show examples with, respectively, lfsr_test (an iterator coroutine), and lfsr (a generator coroutine). lfsr implements a Galois linear-feedback shift register. lfsr stores the current value of the shift register locally in storage elements and synchronously emits a series of output bits. After the first output bit is sent, lfsr waits for a message with index 1. Non-zero messages trigger lfsr to send the next output. A zero message terminates lfsr. lfsr_test invokes lfsr once and iterates over its outputs. Every bit that lfsr_test receives from lfsr is printed using the printf subroutine (not shown).

When multiple F is are run without synchronization by message passing, they can run as parallel threads in separate tiles. The degree to which multi-threading occurs in hardware depends on the number of tiles and the scheduling that is performed by the microarchitecture (see above).

FIG. 7D shows a quicksort example that can utilize multithreading capabilities. After the input array is split into two smaller sub-arrays based on comparison with the pivot element, separate threads are launched for recursive sorting of the sub-arrays. quicksort waits for the completion of both threads before returning. Different RMIs, 1 and 2, are used to differentiate between return messages of the two separately spawned quicksort threads.

### EXAMPLE

This embodiment was physically implemented, and is below compared with other array-based designs and a RISC CPU core. The microarchitecture 70 was implemented at register-transfer level in SystemVerilogand verified against a Python reference model. Extensive hierarchical clock gating was employed to minimize clock activity at flip-flops and throughout the clock tree. Clock gate insertion was performed manually.

The design was synthesized, placed and routed in GlobalFoundries (trade mark) 22 nm FD-SOI CMOS using Design Compiler (trade mark) and IC Compiler II (trade mark) of Synopsys (trade mark). Metal fill was included to meet manufacturing criteria.

With its unusually small ratio of switching activity to gate area, implementation with standard cells based on regular-V_{T} transistors would have led leakage power to outweigh switching power.

To reduce leakage power and make it possible to compete with small RISC cores in spite of a significantly larger core area, ultra-low-leakage standard cells based on transistors with high V_{T} were used.

Figures for Pasithea-1 are based on simulations of the fully placed-and-routed design including extracted parasitics. Power analysis and static timing analysis were performed using Synopsys PrimeTime (trade mark). Activity vectors from postimplementation netlist simulations with timing annotation were utilized.

The present example ran with a nominal supply voltage of 0.8 V. The use of ultra-low-leakage standard cells, motivated as described above, came with a large performance penalty, limiting clock frequency to 40 MHz. Table 5 summarizes area, static power and key cell counts of the implemented design.

TABLE 5
Design summary after physical implementation,
excluding physical-only cells.

| | Tile | Memory | Top-level | Total |
|---|---|---|---|---|
| Num. FF/Lat. | 3813 | — | 3943 | 34447 |
| Clock gates | 100 | — | 44 | 844 |
| Area [μm²] | 28,026 | ~300,000 | 21,610 | 545,818 |
| Static power [μW] | 0.16 | 0.55 | 0.11 | 1.94 |

For benchmarking, five test cases were run on Pasithea1. The gcd benchmark consists of a single invocation of the gcd fragment (see Table 4) performing 19 iterations. The mul benchmark consists of a single invocation of a shift-and-add multiplication subroutine that completes in 16 iterations. nop_loop consists of a loop of add instructions repeatedly operatingon zeros. The lfsr example is shown in FIG. 7C, printf not included. Testcase 5 uses shift-and-subtract div for trial division alongside mul to perform primality testingon the number 4799. F eviction and restoring was functionally verified, but is not covered in the presented test cases.

Fetches per instruction (FPI) was used as a metric of instruction reuse efficiency. Results for the test cases are shown in Table 6, including number of instruction fetches (including prefixes), number of executed instructions (excluding prefixes), cycle counts, cycles per instruction (CPI) and fetches per instruction (FPI). The FPI of a RISC implementation without spatially distributed execution will be 1 or greater, depending on the number of misfetches. In comparison, Pasithea-1 reduces instruction fetching by more than 80% in mul and gcd. The lfsr coroutine test case and the primality test take more cycles to complete, during which they benefit further from instruction reuse with over 90% reuse efficiency. For cooperating coroutines and repeated subroutine calls (printf, mul, div), the microarchitecture maintains in-fabric presence of all fragments throughout the test cases, thus requiring only an initial fetch phase per fragment.

TABLE 6
Number of instruction fetches, number of executed instructions,
cycle counts, CPI and FPI for Pasithea-1 test cases

| | | Num. | Num. | Num. | | |
|---|---|---|---|---|---|---|
| # | Fragment | IF | Ex. | Cyc. | CPI | FPI |
| 1 | gcd | 11 | 60 | 122 | 2.03 | 0.18 |
| 2 | mul | 10 | 64 | 114 | 1.78 | 0.16 |
| 3 | nop_loop (exec only) | — | 1105 | 1105 | 1.00 | — |
| 4 | lfsr example | 78 | 1013 | 2551 | 2.52 | 0.07 |
| 5 | primality test | 103 | 2509 | 4826 | 1.92 | 0.04 |

| | | |
|---|---|---|
| Average (# 1, 4, 6, 7) | 2.06 | 0.11 |

Table 6 furthermore provides cycles per instruction (CPI) for the given test cases as a per-cycle performance metric. Only nop_loop achieves 1 CPI. In the other test cases, execution with S prefixes (+1 cycle), fragment invocation (at least 12 cycles latency), instruction fetching (+1 cycle per word) and communication between F is reduce per-cycle performance to an average of 2.06 CPI.

When comparing those results with other processors, differences in instruction sets need to be accounted for. Pasithea-1 instructions are potentially more powerful than RISC instructions: every instruction can branch, a single communication instruction can replace multiple RISC instructions and no instructions are necessary for register saving/restoring and stack memory access for subroutine calls.

Table 7 shows dynamic power consumption per frequency.

TABLE 7
Dynamic power consumption of Pasithea-1,
ARM Cortex-M0+ and DiAG.

| | | Num. | Dynamic Power per Freq. [μW/MHz] = [pJ] | | | |
|---|---|---|---|---|---|---|
| # | Fragment | IF | tile | mem | top-lev. | total |
| 1 | gcd | 11 | 2.05 | 0.12 | 0.22 | 2.39 |
| 1a | gcd (load | 11 | 2.42 | 0.79 | 0.80 | 4.01 |
| | only) | | | | | |
| 1b | gcd (exec | 0 | 1.99 | 0.00 | 0.13 | 2.11 |
| | only) | | | | | |
| 2 | mul | 10 | 1.69 | 0.15 | 0.25 | 2.08 |
| 3 | nop_loop | 0 | 0.54 | 0.00 | 0.01 | 0.55 |
| | (exec only) | | | | | |
| 4 | lfsr_test | 15 | 0.32 | 0.18 | 0.31 | 2.45 |
| | lfsr | 11 | 0.15 | | | |
| | printf | 52 | 0.92 | | | |
| | | | 0.32 | | | |
| | | | 0.14 | | | |
| | | | 0.10 | | | |
| 5 | prime_test | 13 | 0.03 | 0.03 | 0.14 | 1.86 |
| | is_prime | 51 | 0.23 | | | |
| | | | 0.13 | | | |
| | | | 0.06 | | | |
| | | | 0.01 | | | |
| | div | 29 | 0.87 | | | |
| | | | 0.18 | | | |
| | mul | 10 | 0.18 | | | |

| | | | |
|---|---|---|---|
| Average (# 1, 4, 6, 7) | 0.12 | 0.23 | 2.19 |

| | |
|---|---|
| Comparison to ARM Cortex-M0+/Dhrystone | 3.65 |
| Comparison to DiAG | 120 |

This quantifies switching activity and corresponds to energy per cycle. The tile column is split between separate tiles within the test cases.

For gcd, separate figures for fetch and execution phases are provided. Instruction movement during fetching is reflected in elevated switching activities of memory, top-level and tile, exceeding those during actual computation.

During execution of nop_loop, switching activity drops by a factor of about four. In this test case, only control flow (including one conditional branch every 12 instructions) and no operand sends occur. This highlights the efficiency of hierarchical clock gating to inhibit unnecessary switching throughout the clock tree and at clock endpoints in spite of a large number of total flip-flops.

Test cases 4 and 5 show that the spatial instruction distribution entails a spatial power distribution. The first tiles of printf and div can be identified as execution hotspots, which disproportionately benefit from instruction reuse due to high activity levels.

Pasithea-1 was compared with a minimal RISC reference system comprising an ARM Cortex-M0+ CPU core and a 12 kB on-chip SRAM (Lallement et al., A 1.1-pJ/cycle, 20-MHz, 0.42-v temperature compensated ARM cortex-m0+ SoC with adaptive self body-biasing in FD-SOI, IEEE Solid-State Circuits Letters, 1(7) (2018) pp. 174-177). The reference system was chosen based on the fact that it is implemented in the same 22 nm technology as our architecture and because it exhibited the highest energy efficiency of all small RISC implementations that we were aware of. From this reference, power consumption figures for a matching supply voltage of 0.8 V were used in order to exclude the effect of voltage scaling. Static power was subtracted. This reveals that our microarchitecture operates with a 40% lower per-cycle switching activity than the RISC reference system.

Other low-power array architectures for which power figures were available are understood to exhibit higher per-operation switching activities than the RISC system that we chose as reference (see Govindan et al., TRIPS: A distributed explicit data graph execution (EDGE) microprocessor, in 2007 IEEE Hot Chips 19 Symposium (HCS), IEEE, August 2007), Bohnenstiehl et al., KiloCore:A32-nm 1000-processor computational array, IEEE Journal of Solid-State Circuits, 52(4) (2017) pp. 891-902) and Cerqueira et al., Catena: A near-threshold, sub-0.4-mW, 16-core programmable spatial array accelerator for the ultralow-power mobile and embedded internet of things, IEEE Journal of Solid-State Circuits, 55(8) (2020) pp. 2270-2284).

For DiAG, an in-place processor we consider closest to our architecture in structure and aim, a significantly larger power figure was reported (see Wang and Kim, 2021). In addition to the streamlined design of the present embodiment, this mismatch is attributed to the facts that DiAG includes FPUs, multipliers, a complex memory subsystem, supports out-of-order execution and is based on a different technology and logic library.

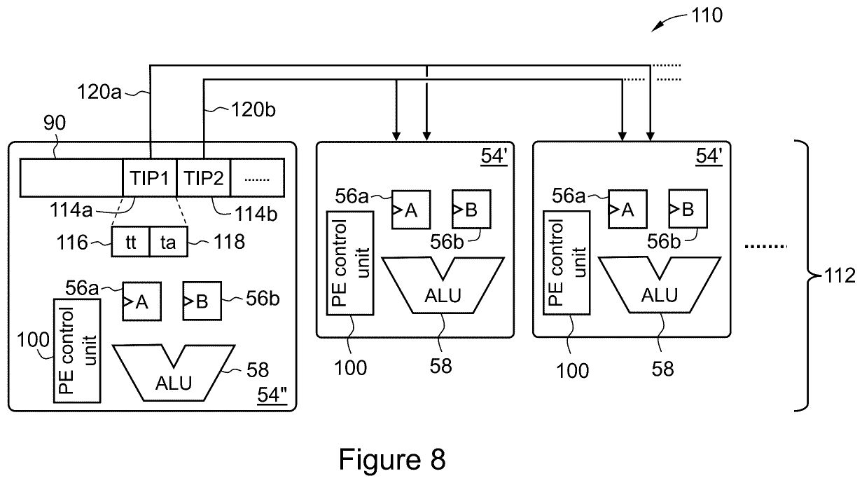

FIG. 8 is a simplified schematic diagram 110 of a PE array 112 of a further processing architecture according to another embodiment of the present invention. The processing architecture of this embodiments comparable to that of FIGS. 4A to 4C, and includes a plurality of fabric cells or tiles each having a PE array 112 connected via an S bus (not shown). Array 112 and its constituent PEs are essentially identical with array 52 of FIG. 4B and PE 54′ of 4C.

Referring to FIG. 8, array 112 includes N PEs 54′, one of which (for the purposes of this example, the source or originating PE) is labelled PE 54″ and illustrated in greater detail. Note that source PE 54″ is identical with the other (or ‘target’) PEs, and any one or more of the N PEs 54′ can act as a source PE.

Source PE 54″ includes, inter alia, first and second storage elements 56a, 56b, an arithmetic-logic unit (ALU) 58, an instruction register (IR) 90 and a PE control unit 100. IR 90 includes a plurality of send slots ortarget instruction pointers (TIPs) of an instruction loaded in the PE 54″. For simplicity, two representative TIPs 114a, 114b are depicted, but it should be understood that IR 90 typically includes four TIPs: two from the primary instruction word, and two from the S prefix (see FIG. 5). (If the S prefix is omitted, the corresponding TIPs remain inactive.) Each TIP 114a, 114b can encode either dataflow (for dataflow coordination) or conditional branching (for control flow coordination), and includes a target type/send type field (tt or st) 116 and a target address/send address field (ta or sa) 118 (the abbreviations st and sa being used in FIG. 5). A range of logical connections are possible between source PE 54″ and a target PE, and encodable by each TIP 114a, 114b of source PE 54″. FIG. 8 depicts examples of such logical connections, including first logical connection 120a from source PE 54″ to at least two target PEs and second logical connection 120b from source PE 54″ to at least two target PEs, but it should be noted that—at any point in time—each TIP 114a, 114b points to at most one local destination PE. A particular, specified action is encoded in tt 116 (see Table 1) of the respective TIP 114a, 114b; this encoded action is performed each time source PE 54″ executes its instruction. More precisely, the action is performed at the end of executing its instruction. The S bus is used to execute the logical action encoded in the respective TIP 114a, 114b.

### Discussion

The Computing Array Approach and Exemplary Instruction Set and a Microarchitecture Presented above were aimed at finding a general-purpose architecture that reduces instruction movement by spatial distribution of instructions into PEs. Using a small-scale 128PE array, over 80% instruction reuse was achieved in a small set of integer-based test routines. In comparison to a RISC reference system, this led to a 40% reduction of per-cycle switching activity, a promising result for low-power and high-performance computing systems.

The present embodiment can attain PE densities exceeding 500 PEs/mm², which is equivalent to more than 2 kB of running machine code per mm².

It has also be demonstrated that, according to this embodiment, easy, sequential programming of architecture 20 is possible and requires no knowledge of the underlying array structure. It is envisaged that compilers can be adopted to the presented execution model without significant obstacles.

With falling levels of instruction movement, the relative contribution of data movement to energy consumption grows. For memory access and message passing, high PE densities will help to keep path lengths short in order to reduce switching energy. Spatial distribution of instructions also creates new possibilities for tighter spatial coupling between processing and data storage resources.

It will be understood by persons skilled in the art of the invention that many modifications may be made without departing from the scope of the invention. In particular it will be apparent that certain features of embodiments of the invention can be employed and combined to form further embodiments.

It is to be understood that, if any prior art is referred to herein, such reference does not constitute an admission that the prior art forms a part of the common general knowledge in the art in any country.

In the claims that follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A processing element array of a processor, comprising:
a plurality of processing elements or nodes, each of the processing elements including at least one instruction register, a control unit, at least one arithmetic or logic unit, and one or more storage elements, and being configured to store, decode and execute an instruction;
wherein the instruction register and the storage elements are configured to be writable from one or more data buses; and
the arithmetic or logic unit is configured to receive input from one of the storage elements and to output a result to one or more other processing elements of the array of processing elements via the one or more data buses.

2. An array as claimed in claim 1, wherein the arithmetic or logic unit is configured to pass the result to one or more storage elements of the other processing elements of the array of processing elements.

3. An array as claimed in either claim 1, wherein each of the processing elements includes a third storage element writable from the data bus and a multiplexer intermediate the first storage element and the arithmetic-logic unit, the multiplexer being configured to receive inputs from the first and third storage elements and to pass selected outputs to the arithmetic-logic unit.

4. An array as claimed in claim 1, wherein each of the processing elements includes a control unit configured such that when an instruction encodes a conditional branch, the control unit determines a branch decision based on a send type of the instruction and the result outputted by the arithmetic-logic unit being zero.

5. An array as claimed in claim 1, wherein the instructions encode operations that are basic enough to require no intermediate translation into microinstructions before execution.

6. An array as claimed in claim 1, wherein the instructions have respective formats that facilitate simple fetching and decoding.

7. An array as claimed in claim 1, wherein the instructions support a minimal set of operand types and less common operand types require dedicated instructions.

8. An array as claimed in claim 7, wherein each of the processing elements receives input data primarily from two storage elements that are statically associated with the respective processing element.

9. An array as claimed in claim 1, wherein
the instruction register of a first processing element of the plurality of processing elements supports a plurality of target instruction pointers, defining respective logical connections between the first processing element and one or more other processing elements of the plurality of processing elements;
one or more of the target instruction pointers are configured for dataflow coordination or control flow coordination; and
one or more of the target instruction pointers are configured for dataflow coordination.

10. A fabric cell or tile of a processor, comprising:
a processing element array as claimed in claim 1;
an S bus that constitutes the data bus; and
a cell or tile interface node;
wherein the interface node connects an external message bus to the S bus of the fabric cell;
the S bus implements the datapath of the processing elements, and facilitates data exchange between the processing elements, and between the interface node and the cell or tile interface node and processing elements;
the interface node comprises a plurality of message registers and is configured to forward instructions to the processing elements, coordinate eviction and restoring locally, and assist the processing elements during the execution of communication and fragment instance management instructions.

11. A fabric cell or tile as claimed in claim 10, comprising one or more S/T links for connecting the S bus to respective S buses of one or more adjacent fabric cells or tiles via respective T links.

12. A fabric cell or tile as claimed in claim 11, wherein the interface node serves as an interface for a plurality of like fabric cells or tiles.

13. A processor, comprising:
a plurality of fabric cells or tiles as claimed in claim 10;
a message bus;
a fragment instance manager;
a fragment instance table; and
a memory.

14. A processor as claimed in claim 13, implementing dynamic tiling so as to support linkage of a plurality of tiles.
